(19) United States
(12) Patent Application Publication
(10) Pub. No.: US 2002/0172880 A1
(43) Pub. Date: Nov. 21, 2002

(54) Dry color toner for electrostatic image development

(75) Inventors: Hitoshi Takayanagi, Saitama-shi (JP); Takashi Ito, Tokyo (JP); Katsuyuki Ogura, Saitama-shi (JP)

Correspondence Address: ARMSTRONG,WESTERMAN & HATTORI, LLP, 1725 K STREET, NW., SUITE 1000, WASHINGTON, DC, 20006, US

(73) Assignee: Dainippon Ink and Chemicals, Inc., Tokyo (JP)

(21) Appl. No.: 10/082,089

(22) Filed: Feb. 26, 2002

(30) Foreign Application Priority Data
Mar. 1, 2001 (JP) P2001-056636

(51) Int. Cl. G03G 9/09

(52) U.S. Cl. 430/108.23; 430/137.1; 430/110.3

(57) ABSTRACT

A spherical dry color toner for electrostatic image development produces a clear image after printing and has an excellent color reproducibility in color overlapping during multi-color printing, and also yields an image having a transparency fixed on an OHP sheet and can achieve a clear color free from turbidity when projected on a screen. A spherical dry color toner for electrostatic image development comprises a binder resin and an organic pigment dispersed finely in the binder resin, wherein the organic pigment is an organic pigment represented by the formula 1:

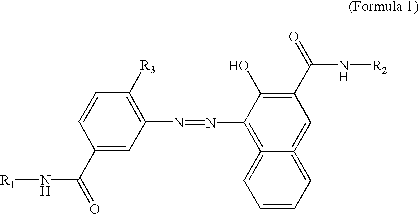

wherein R₁ represents a non-substituted phenyl group or a phenyl group having a substituent, R₂ represents hydrogen, a non-substituted phenyl group or a phenyl group having a substituent, and R₃ represents an alkoxy group or an ester group.

### BACKGROUND OF THE INVENTION

1. Field of the Invention

The present invention relates to a spherical dry color toner for electrostatic image development, which is preferably employed in electrophotographic copying machines, printers, and facsimiles, and is also employed in toner-jet printers. More particularly, the present invention relates to a spherical dry magenta toner for electrostatic image development, which is employed for various purposes described above.

2. Description of Related Art

Toner compositions produced by dispersing a black colorant such as carbon black in a binder resin are often used to obtain a visible image by means of the electrophotographic method. However, full-color or monochrome copying machines and printers have recently been developed which employ color toners produced by dispersing a chromatic color pigment such as cyan pigment, magenta pigment, or yellow pigment in a binder.

Properties required of these color toners include color reproducibility, for example, the image after printing has a clear color developability, the color toner exhibits an excellent transparency in color overlapping during multi-color printing and has a clear color reproducibility without causing color turbidity, or the color toner achieves a clear color free from turbidity when projected a color image obtained by transferring and fixing on an overhead projector (hereinafter referred to as an OHP) sheet on a screen.

Furthermore, cost reduction and size reduction of machines as well as power saving and resource conservation have recently been studied. With the spread of color printers and color copying machines, high definition and a broad gradational range have been required in printing properties of machines. Thus, properties, which enable one to conduct printing having the same definition and gradation as those in the case of offset printing, have been required of toners.

To improve the definition and gradation of the printed image, the particle size of the toner must be reduced compared with a conventionally used toner having an average particle size within a range from 7-15 μm. Since the content of a colorant in a conventional toner is within a range from about 2-5%, a comparatively large amount of the toner must be transferred and fixed onto a material to be printed so as to obtain a desired printing density. As a result, the toner has such drawbacks that the resulting printed image has a large thickness as compared with a print, which is obtained by using an offset printing ink containing a pigment in the amount which is several to several tens of times as much as that of the toner, resulting in different volume. This tendency is particularly conspicuous in the case of reproducing neutral tints by printing with overlaying plural color toners. For example, in the case of printing on a matte coated paper or wood free paper, the resulting printed image has a volume, that is different from that of a paper, and also has a gloss, thus making it difficult to conduct subdued printing.

Therefore, color toners have recently been desired which contain a large amount of colorant, which have a small particle size, and which do not remain on an intermediate transferring material after being developed on a photosensitive material so as to be transferred onto a material to be printed, such as paper, at a high transfer efficiency. Such a color toner can reproduce the same image quality and volume as those in the case of offset printing and can also reduce the amount of the toner required for printing, thus making it possible to reduce the printing cost.

A pulverization method has mainly been employed as the method of producing a powdered toner. In principle, a toner having a small particle size can also be produced by the pulverization method. However, a toner having a small particle size produced by the pulverization method is not actually suited for practical use because it has drawbacks that (1) it becomes difficult to control the charge because of an increase in the amount of colorants and waxes exposed on the surface of the toner particles, (2) the fluidity of the powder is lowered by the nonuniform shape of the toner particles and (3) the energy cost required for the production increases, thereby increasing the price of the toner.

Under these circumstances, development of a spherical toner having a small particle size has been made intensively using the polymerization method. Although various methods have been known as the method of producing a toner using the polymerization method, the suspension polymerization method has widely been employed, which comprises uniformly dissolving and dispersing a monomer, a polymerization initiator, a colorant and a charge control agent, adding the mixture in an aqueous medium in the presence of a dispersion stabilizer while stirring to form oil droplets and polymerizing the monomer to obtain toner particles. Although the reduction in particle diameter and spheroidizing can be satisfactorily conducted by the suspension polymerization method, a principal component of the binder resin is limited to a radically-polymerizable vinyl polymer and toner particles made of a polyester resin or epoxy resin suited for use as a color toner cannot be produced by the suspension polymerization method. It is difficult to reduce VOC (volatile organic compound made of an unreacted monomer) by the suspension polymerization method.

In a conventionally used magenta toner, a quinacridone pigment C.I. PIGMENT RED 122 or a lake pigment C.I. PIGMENT RED 57:1 has mainly been used as the organic pigment. The former has a good color hue and is superior in blue color reproducibility, but has poor dispersibility to the resin for toner and is inferior in tinting power. Therefore, the content of the pigment in the toner must be increased so as to conduct printing with a desired density, thus causing such a problem that charge properties of the toner are liable to become unstable.

The latter has a good tinting power, but has a drawback in that it has a hygroscopicity because of its Ca salt structure and, therefore, the charge properties of the toner is liable to be influenced by the environment. Therefore, it cannot be said that the pigment is suited for use as a material used in the method of producing toner particles in an aqueous medium, such as the suspension polymerization method described above. When an alkali substance must be used as the dispersion stabilizer, the pigment is likely to react with the alkali substance to cause deterioration because of its poor alkali resistance. Therefore, it was difficult to produce, as a magenta toner, a spherical toner having a small particle size, which has a tinting power and is superior in gradation, definition and transferrability, by using a conventional material.

### BRIEF SUMMARY OF THE INVENTION

Under these circumstances described above, the present invention has been achieved and an object thereof is to provide a spherical dry color toner for electrostatic image development, which gives a clear image after printing and has an excellent color reproducibility in color overlapping during multi-color printing, and also which gives an image having a transparency fixed on an OHP sheet and can achieve a clear color free from turbidity when projected on a screen. Another object of the present invention is to provide a spherical dry color toner for electrostatic image development having a small particle size, which has a large content of a colorant as compared with a conventional color toner Still another object of the present invention is to provide a spherical dry color toner for electrostatic image development, which does not remain on an intermediate transferring material after being developed on a photosensitive material so as to be transferred onto a material to be printed, such as paper, at a high transfer efficiency. A further object of the present invention is to provide a method of producing a spherical dry color toner for electrostatic image development, which achieves the objects described above. A still further object of the present invention is to provide a magenta-colored and spherical dry color toner for electrostatic image development and a method of producing the same, which achieve the objects described above.

As a result of diligent research, the present inventors have found that the objects described above can be achieved by employing a spherical dry color toner that uses a magenta pigment having a specific structure, thus completing the present invention.

That is, the present invention provides a spherical dry color toner for electrostatic image development, comprising a binder resin and an organic pigment dispersed finely in the binder resin, wherein the organic pigment is an organic pigment represented by the formula 1:

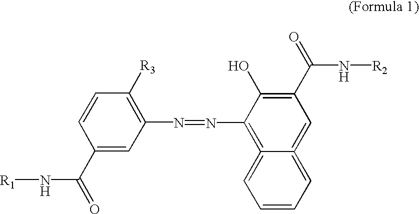

wherein R₁ represents a non-substituted phenyl group or a phenyl group having a substituent, R₂ represents hydrogen, a non-substituted phenyl group or a phenyl group having a substituent, and R₃ represents an alkoxy group or an ester group.

The present invention also provides a method of producing the above spherical dry color toner for electrostatic image development, which comprises mixing a mixture containing a binder resin having a carboxyl group and an organic pigment represented by the formula 1 with an aqueous medium in the presence of a base to prepare a colored particle suspension containing the mixture, as color particles, emulsified in the aqueous medium, separating the colored particles from the colored particle suspension, and drying the colored particles.

The spherical dry color toner for electrostatic image development of the present invention is made superior in transfer efficiency, definition, gradation and image density by spheroidizing and size reduction using an organic pigment having a specific structure. The content of the pigment can be increased as compared to the toner produced by a conventional pulverization method, thus making it possible to conduct high-quality printing which has a volume suited for a surface condition of a paper.

### DETAILED DESCRIPTION OF THE INVENTION

The present invention will now be described in detail. The dry color toner for electrostatic image development of the present invention comprises at least a binder resin and an organic pigment of the formula 1, and the binder resin employed in the present invention is not specifically limited as long as it does not interfere with the objects of the present invention. Specific examples thereof include vinyl copolymer resin such as polystyrene resin, styrene-acrylic resin, or styrene-butadiene resin, and polyester resin, epoxy resin, butyral resin, xylene resin, and coumarone-indene resin. Among these binder resins, vinyl copolymer resin and polyester resin are preferred, and polyester resin can be employed particularly preferably because of its good balance between the fixing properties, anti-offset properties and transparency.

The polyester resin is synthesized by dehydration condensation of a polybasic acid and a polyhydric alcohol. Examples of the polybasic acid include aromatic carboxylic acids such as terephthalic acid, isophthalic acid, phthalic anhydride, trimellitic anhydride, pyromellitic acid, and naphthalenedicarboxylic acid; aliphatic carboxylic acids such as maleic anhydride, fumaric acid, succinic acid, alkenylsuccinic anhydride, and adipic acid; and alicyclic carboxylic acids such as cyclohexanedicarboxylic acid. These polybasic acids can be used alone or in combination. Among these polybasic acids, an aromatic carboxylic acid is preferably employed.

Examples of the polyhydric alcohol include aliphatic diols such as ethylene glycol, diethylene glycol, triethylene glycol, propylene glycol, butanediol, hexanediol, neopentyl glycol, glycerin, trimethylolpropane, and pentarythritol; alicyclic diols such as cyclohexanediol, 1,4-cyclohexanedimethanol, and hydrogenated bisphenol A; and aromatic diols such as ethylene oxide adduct of bisphenol A and propylene oxide adduct of bisphenol A. These polyhydric alcohols can be used alone or in combination. Among these polyhydric alcohols, aromatic diols and alicyclic diols are preferred and aromatic diols are more preferred.

A hydroxyl group at polymer terminal and/or a carboxyl group may be esterified by further adding monocarboxylic acid and/or monoalcohol to the polyester resin obtained by the polycondensation of the polyhydric carboxylic acid and polyhydric alcohol, thereby controlling the acid value of the polyester resin.

Examples of the monocarboxylic acid employed for the purpose include acetic acid, acetic anhydride, benzoic acid, trichloroacetic acid, trifluoroacetic acid, and propionic anhydride. Examples of the monoalcohol include methanol, ethanol, propanol, octanol, 2-ethylhexanol, trifluoroethanol, trichloroethanol, hexafluoroisopropanol, and phenol.

The polyester resin can be produced by the condensation reaction of the polyhydric alcohol and polyhydric carboxylic acid according to a conventional method. For example, it can be produced by charging the polyhydric alcohol and polyhydric carboxylic acid in a reaction vessel equipped with a thermometer, a stirrer and a dropping condenser, heating them to 150-250° C. in the presence of an inert gas (e.g. nitrogen gas), continuously removing a low-molecular compound out of the reaction system, terminating the reaction at a point in time when the acid value reached a predetermined value, and cooling to obtain a desired reaction product.

In the synthesis of the polyester resin, a catalyst may be employed. Examples of the catalyst include esterification catalysts, for example, organometallic compound (e.g. dibutyltin dilaurate and dibutyltin oxide, etc.) and metal alkoxide (e.g. tetrabutyl titanate, etc.). In the case in which the carboxylic acid component is a lower alkyl ester, ester interexchange catalysts can be used, for example, metal acetate (e.g. zinc acetate, lead acetate, magnesium acetate, etc.), metal oxide (e.g. zinc oxide, antimony oxide, etc.) and metal alkoxide (e.g. tetrabutyl titanate, etc.). The amount of the catalyst is preferably within a range of 0.01-1% by weight based on the total amount of the raw materials.

In the polycondensation reaction, a polybasic acid having three or more carboxyl groups in a molecule or an anhydride thereof and/or a polyhydric alcohol having three or more hydroxyl groups in a molecule may be used to prepare a crosslinked polyester resin.

The vinyl copolymer, which can be employed in the present invention is preferably a copolymer resin of a styrene (meth)acrylate ester. Examples of the styrene monomer include styrene, α-methylstyrene, vinyltoluene, and dimethylaminoethylstyrene.

Examples of the (meth)acrylate ester monomer include alkyl (meth)acrylate such as methyl (meth)acrylate, ethyl (meth)acrylate, n-propyl (meth)acrylate, isopropyl (meth)acrylate, n-butyl (meth)acrylate, isobutyl (meth)acrylate, tertiary butyl (meth)acrylate, octyl (meth)acrylate, 2-ethylhexyl (meth)acrylate, lauryl (meth)acrylate, or stearyl (meth)acrylate; alicyclic (meth)acrylate such as cyclohexyl (meth)acrylate; aromatic (meth)acrylate such as benzyl (meth)acrylate; hydroxyl group-containing (meth)acrylate such as hydroxyethyl (meth)acrylate; phosphoric acid group-containing (meth)acrylate such as (meth)acryloxyethyl phosphate; halogen atom-containing (meth)acrylate such as 2-chloroethyl (meth)acrylate, 2-hydroxy-3-chloropropyl (meth)acrylate, or 2,3-dibromopropyl (meth)acrylate; epoxy group-containing (meth)acrylate such as glycidyl (meth)acrylate; ether group-containing (meth)acrylate such as 2-methoxyethyl (meth)acrylate or 2-ethoxyethyl (meth)acrylate; and basic nitrogen atom- or amide group-containing (meth)acrylate such as dimethylaminoethyl (meth)acrylate or diethylaminoethyl (meth)acrylate.

A copolymerizable unsaturated compound can also be used, if necessary. For example, a carboxyl group-containing vinyl monomer can be used such as (meth)acrylic acid, itaconic acid, crotonic acid, maleic acid, or fumaric acid; sulfo group-containing vinyl monomer such as sulfoethylacrylamide; nitrile group-containing vinyl monomer such as (meth)acrylonitrile; ketone group-containing vinyl monomer such as vinyl methyl ketone or vinyl isopropenyl ketone; and basic nitrogen atom- or amide group-containing vinyl monomer such as N-vinylimidazole, 1-vinylpyrrole, 2-vinylquinoline, 4-vinylpyridine, N-vinyl-2-pyrrolidone, or N-vinylpiperidone.

A crosslinking agent can be used in an amount within a range of 0.1-2% by weight based on the vinyl monomer. Examples of the crosslinking agent include divinylbenzene, divinylnaphthalene, divinyl ether, ethylene glycol di(meth)acrylate, diethylene glycol di(meth)acrylate, triethylene glycol di(meth)acrylate, polyethylene glycol di(meth)acrylate, 1,3-butylene glycol di(meth)acrylate, 1,6-hexane glycol di(meth)acrylate, neopenthyl glycol di(meth)acrylate, propylene glycol di(meth)acrylate, dipropylene glycol di(meth)acrylate, polypropylene glycol di(meth)acrylate, trimethylolpropane tri(meth)acrylate, and tetramethylolmethane tetra(meth)acrylate.

As the method of producing the copolymer of styrene (meth)acrylate ester, a conventional polymerization method can be used. Examples thereof include methods of conducting the polymerization reaction in the presence of a polymerization catalyst, for example, solution polymerization, suspension polymerization, and bulk polymerization.

Examples of the polymerization catalyst include 2,2′-azobis(2,4-dimethylvaleronitrile), 2,2′-azobisisobutyronitrile, 1,1′-azobis(cyclohexane-1-carbonitrile), benzoyl peroxide, dibutyl peroxide, and butylperoxy benzoat, and the amount is preferably within a range of about 0.1-10.0% by weight based on the vinyl monomer component.

The glass transition temperature (Tg) of the binder resin employed in the present invention is preferably 50° C. or higher, and particularly preferably 55° C. or higher. When the glass transition temperature Tg is lower than 50° C., the resulting toner tends to cause blocking (thermal agglomeration) during the storage or conveying, or exposure to high temperature in a developing apparatus.

The melting point of the binder resin employed in the present invention is 90° C. or higher, preferably within a range of 90-180° C., and more preferably within a range of 95-160° C. When the softening point is lower than 90° C., the toner is liable to cause agglomeration phenomenon, resulting in problems during the storage and printing. On the other hand, when the softening point exceeds 180° C., the fixation properties are often lowered.

In the case in which the color reproducibility during the color overlapping and the transparency during the fixation on the OHP sheet are required in the full-color toner, the softening point of the toner is preferably within a range of 90-130° C., and more preferably in a range of 95-120° C.

The melting point of the resin in the present invention is defined by a T1/2 as measured by employing a Flow Tester “CFT-500” manufactured by Shimadzu Corporation as a constant load extrusion type capillary rheometer. Employing a flow tester, the measurement was conducted under the conditions of a piston cross section of 1 cm² a cylinder pressure of 0.98 MPa, a die length of 1 mm, a nozzle diameter D of 1 mm, a measurement initiation temperature of 50° C., a heating rate of 6° C./min. and a sample weight of 1.5 g.

The acid value of the binder resin used in the present invention is preferably within the range of 1-30. The acid value is preferably within the above range in the production of the spherical toner. The environmental stability is improved when used as the toner.

The shape of a toner particle in the spherical dry toner for electrostatic image development of the present invention is not specifically limited as long as the toner particle has a curved surface. Examples thereof include a completely spherical or rugby ball-shaped toner particle having a single curved surface, and a grape-shaped toner particle covered with plural curved surfaces. In the present invention, preferred are spherical or generally spherical toner particles having the average roundness of 0.93 or more defined by the following equation:

$$Average roundness = \frac{\begin{matrix}Perimeter of a circle having the same area \\ as that of a projected area of particles\end{matrix}}{Perimeter of a projected image of particles}$$

The average roundness is preferably 0.97 or more, and particularly preferably 0.98 or more.

The average roundness is also determined by taking a SEM (scanning electron microscope) photograph of the toner particles, followed by measurement and calculation. In the present invention, the average roundness is measured by employing a flow type particle image analyzer FPIP-1000 manufactured by Toa Iyo Denshi Co., Ltd. The flow type particle image analyzer FPIP-1000 is an apparatus for taking a photograph of the size and shape of microparticles such as toner particles and the photograph of the particles is taken in the following manner.

First, the respective samples are made by suspending toner particles in water containing a trace amount of a surfactant. Then, each sample is allowed to flow downward in a transparent and flat cell disposed in the flow type particle image analyzer FPIP-1000. A light source for emitting pulsed light is disposed at one side of the cell and, furthermore, a camera is disposed across the cell from the light source. The toner particles in the sample flowing downward in the cell of FPIP-1000 is captured as a still image by irradiating with pulsed light employing the camera disposed across the cell from the light source.

On the basis of the image of the toner particles thus obtained, the configuration of the respective toner particles is extracted and a projected area of the toner particles and a perimeter (perimeter of a projected image of toner particles) are calculated. From the calculated projected area of the toner particles, a length of the circumference of a circle having the same area as that of the toner particles (perimeter of a circle having the same area as that of a projected area of toner particles) is calculated. The above average roundness is determined by dividing the calculated perimeter of a circle having the same area as that of a projected area of particles by the perimeter of a projected image of the toner particles.

Employing the above apparatus, the measurement is conducted under the following conditions.

(1) Preparation of Suspension of Toner Particles

To 20 g of water, 0.1 g of a surfactant (L-Clear, manufactured by CHUGAI PHOTO CHEMICAL Co., Ltd.) was added and 0.04 g of the toner as the sample was added. Employing an ultrasonic dispersing machine, toner particles are suspended in water.

(2) Measuring Conditions

Measuring temperature: 25° C.

Measuring humidity: 60%

Number of toner particles measured: 5000±2000 particles

The dry color toner for electrostatic image development of the present invention can secure a good powder fluidity even if size reduction is conducted by achieving average roundness. Also a good transfer efficiency can be secured, thus obtaining an excellent image quality (definition, gradation). When the average roundness is less than 0.93, that is, the shape is more like an irregular shape from the spherical shape, the transfer efficiency is lowered and, therefore, it is not preferred.

In the present invention, an organic pigment having a structure represented by the above general formula 1 is used. The use of this pigment makes it possible to obtain a color toner having good tinting strength, good gradation, good definition and transfer properties as compared with a magenta pigment that has conventionally been employed in the toner, for example, C.I. Pigment Red 57:1 or C.I. Pigment Red 122 as a quinacridone pigment. It is also possible to print a high-quality image, which shows stable charge behavior during continuous printing and is superior in color reproducibility and transparency.

Specific examples of the organic pigment having a structure represented by the formula 1, which can be used in the present invention, include organic pigments represented by the following formulas 2 to 9.

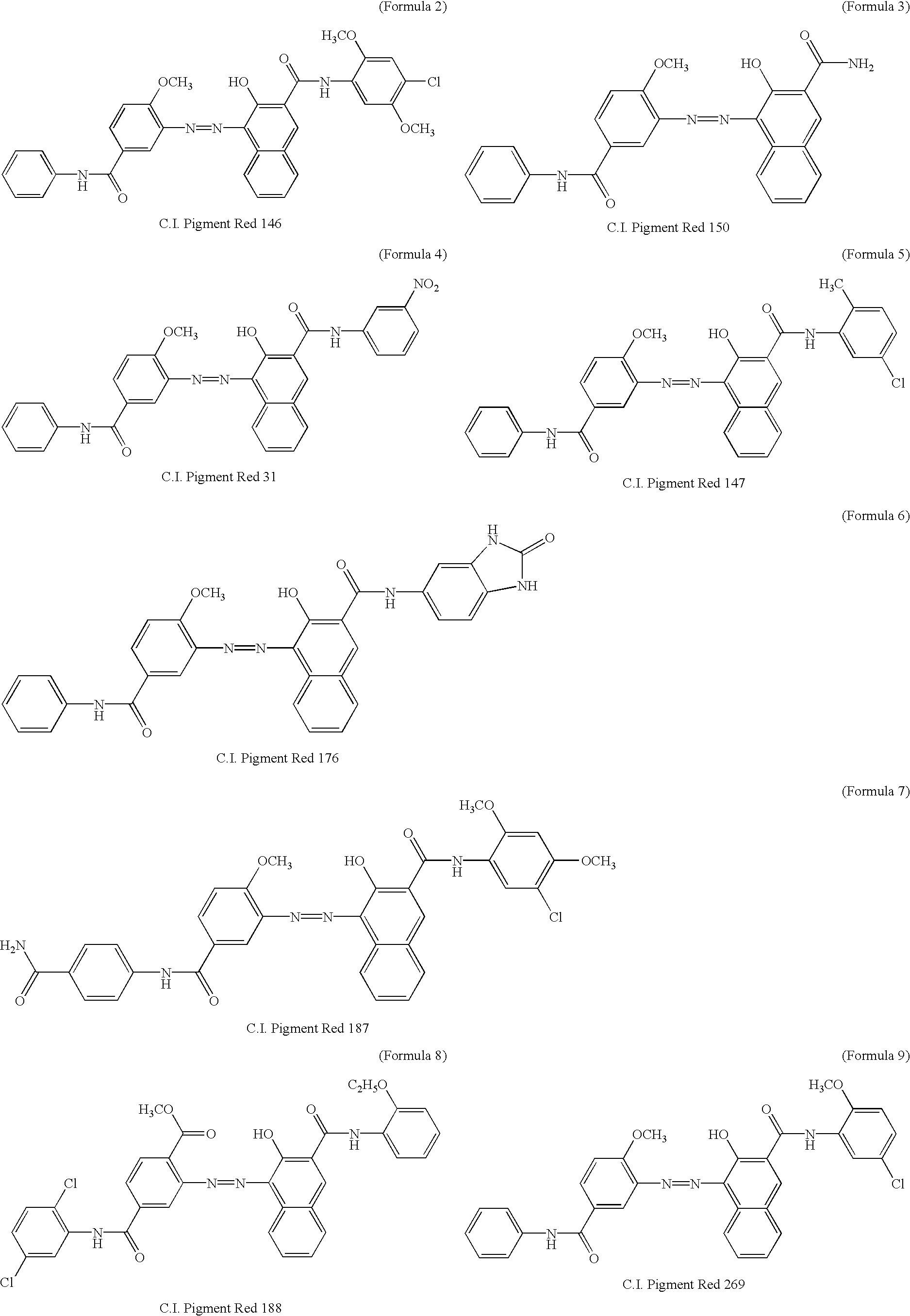

In the present invention, it is particularly preferable to use C.I. Pigment Red 146 of the formula 2 and C.I. Pigment Red 150 of the formula 3 among the organic pigments described above. These organic pigments can also be used in combination.

The amount of the organic pigment of the formula 1 used in the present invention is preferably from 1-50 parts by weight, more preferably from 2-30 parts by weight, and particularly preferably from 2-20 parts by weight, based on 100 parts by weight of the binder resin.

In the present invention, in addition to the organic pigment of the formula 1, other colorants can be used to control the color hue. These colorants include conventionally known colorants. Examples of blue colorants include phthalocyanine C.I. Pigment Blue 15-3 and indanthrone C.I. Pigment Blue 60; examples of red colorants include quinacridone C.I. Pigment Red 122, azo C.I. Pigment Red 22, C.I. Pigment Red 48:1, C.I. Pigment Red 48:3 and C.I. Pigment Red 57:1; examples of the yellow colorants include azo C.I. Pigment Yellow 12, C.I. Pigment Yellow 13, C.I. Pigment Yellow 14, C.I. Pigment Yellow 17, C.I. Pigment Yellow 97, C.I. Pigment Yellow 155, benzimidazolone C.I. Pigment Yellow 151, C.I. Pigment Yellow 154 and C.I. Pigment Yellow 180.

As long as the objects of the present invention are not impaired, the pigments described above can be used in combination with the magenta pigment of the formula 1. For example, an orange toner can be produced by using in combination with the yellow pigment and a bluish purple toner can be produced by using in combination with the cyan pigment. When using the pigment of the formula 1 in combination with the other pigment, the amount of the pigment of the formula 1 is preferably 40% by weight or more, more preferably 50% by weight or more, and particularly preferably 60% by weight or more.

In the toner, various conventionally known waxes, for example, polypropylene wax, polyethylene wax, polyamide wax and Fischer-Tropsch wax can be appropriately used as a releasant. It is preferable to use a wax containing a higher fatty acid ester compound and/or an aliphatic alcohol compound, among these waxes.

Among waxes containing a higher fatty acid ester compound and/or an aliphatic alcohol compound, natural waxes such as carnauba wax, montan ester wax, rice wax and wax from scale insects; and/or synthetic ester waxes are particularly preferred. As the synthetic ester wax, a tetrabehenate ester of pentarythritol is particularly preferable.

These waxes exhibit good dispersibility especially to the polyester resin and markedly improve the fixing properties and anti-offset properties. When using these waxes as a toner for non-magnetic one-component development in the case of printing a number of sheets over a long time, they stably charge the toner without being deposited on a charge material pressed against a developing sleeve, thus making it possible to print a high-grade and fine image free from image defects and contamination. When a color toner is produced by using in combination with the colorant of the formula 1 of the present invention, it is made possible to obtain a color toner having excellent transparency as compared with a hydrocarbon wax such as polypropylene wax. The color toner having these properties have transparency and are suited for use in printing on an OHP sheet that requires a sharp projected image, and printing of a natural color having good color reproducibility by overlapping of two or more colors.

A carnauba wax containing no free fatty acid obtained by purifying to remove free fatty acid is preferably used. An acid value of the carnauba wax free from free fatty acid is preferably 3 or less, and more preferably 2 or less. The carnauba wax free from free fatty acid is in the form of a fine crystal as compared with a conventional carnauba wax, and therefore, the dispersibility in the polyester resin is improved. The montan wax is purified from a mineral and is formed into a fine crystal by purification, like carnauba wax, and thus the dispersibility in the polyester resin is improved. The acid value of the montan wax is particularly preferably 30 or less. Rice wax is obtained b purifying rice bran wax and the acid value is preferably 13 or less. The wax from scale insects can be obtained by melting a wax component secreted by larva of scale insects (Ericerus pela) in hot water, separating the upper layer and solidifying the upper layer with cooling, or repeating this operation. The wax from scale insects purified by such a means is white in a solid state and exhibits a very sharp melting point and is therefore suited for use as a wax for toner in the present invention. As a result of purification, the acid value becomes 10 or less, and the acid value of 5 or less is suited for use as the toner.

These waxes may be employed alone or in combination and good anti-offset properties can be obtained by mixing with the binder resin in the amount within a range of 0.3-40 parts by weight, and preferably within a range of 1-30 parts by weight. The amount is more preferably within a range of 1-20 parts by weight. When the amount is smaller than 0.3 parts by weight, the anti-offset properties are impaired. On the other hand, when the amount is larger than 40 parts by weight, the fluidity of the toner becomes inferior and, furthermore, spent carrier occurs as a result of deposition on the surface of the carrier, thereby exerting an adverse influence on charge properties of the toner in the two-development system, and to deposit on a layer control member pressure-welded on a developing roll.

In the present invention, charge control agents can be used, if necessary. Examples of the positive charge control agent include resins containing nigrosine dyes, quaternary ammonium salts, and resins containing quaternary ammonium salts and/or resins having amino groups. Examples of the negative charge control agent include resins containing trimethylethane dye, metal complex salt of salicylic acid, metal complex salt of benzilic acid, copper phthalocyanine, perylene, quinacridone, azo pigment, metal complex salt azo dye, heavy metal-containing acidic dye such as azochrome complex, calixarene type phenol condensate, cyclic polysaccharide, and resins containing carboxyl groups and/or sulfonyl groups.

In the present invention, a colorless charge control agent is preferably used. As the negative charge control agent, BONTORON E-84 (manufactured by Orient Chemical) as a metal complex compound of salicylic acid can be preferably used. As the colorless positive charge control agent, those having a quaternary ammonium salt structure, for example, TP-302, TP-415 and TP-610 (manufactured by Hodogaya Chemical Industries Co., Ltd.), BONTORON P-21 (manufactured by Orient Chemical), and Copy Charge PSY (manufactured by Clariant Japan) are preferably used. Examples of the positive charge control agent having quaternary ammonium groups and/or amino groups include “FCA-201-PS” (manufactured by Fujikura Chemicals Co., Ltd.).

Among these charge control agents, a compound of the following formula 10 and a compound of the following formula 11 can be used particularly preferably as the charge control agent in the present invention.

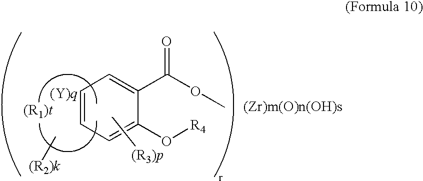

wherein R¹ represents quaternary carbon, methine or methylene and may have a hetero atom such as N, S, O or P; Y represents a cyclic structure bonded through a saturated bond or an unsaturated bond; R₂and R₃each independently represents an alkyl group, an alkenyl group, an alkoxy group, an aryl, aryloxy, aralkyl or aralkyloxy group which may have a substituent, a halogen group, hydrogen, a hydroxyl group, an amino group which may have a substituent, a carboxyl group, a carbonyl group, a nitro group, a nitroso group, a sulfonyl group, or a cyano group; R₄ represents hydrogen or an alkyl; t represents 0 or an integer of 1-12; m represents an integer of 1-20; n represents 0 or an integer of 1-20; k represents 0 or an integer of 1-4; p represents 0 or an integer of 1-4; q represents 0 or an integer of 1-3; r represents 1-20; and s represents 0 or an integer of 1-20;

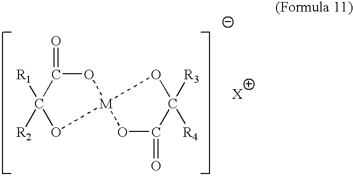

wherein R₁ and R₄ represents a hydrogen atom, an alkyl group, or a substituted- or non-substituted aromatic ring (also containing a condensed ring); R₂ and R₃ a substituted- or non-substituted aromatic ring (also containing a condensed ring); M represents a trivalent metal selected from B, Al, Fe, Ti, Co and Cr; and X⁺ represents a cation.

Specific examples of the compound of the formula 10 include the following <charge control agent 1> to <charge control agent 3>.

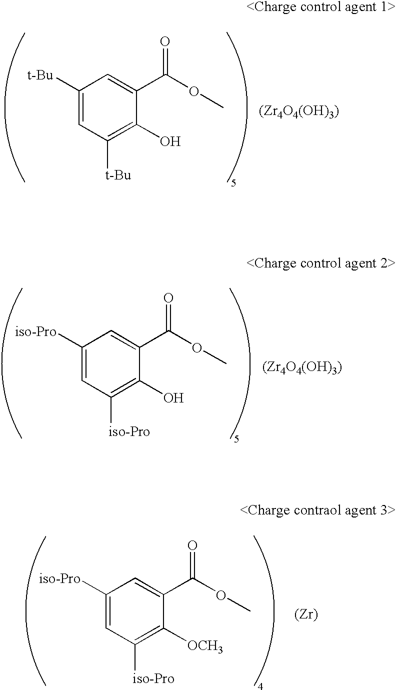

Specific examples of the compound of the formula 11 include the following <charge control agent 4> and <charge control agent 5>.

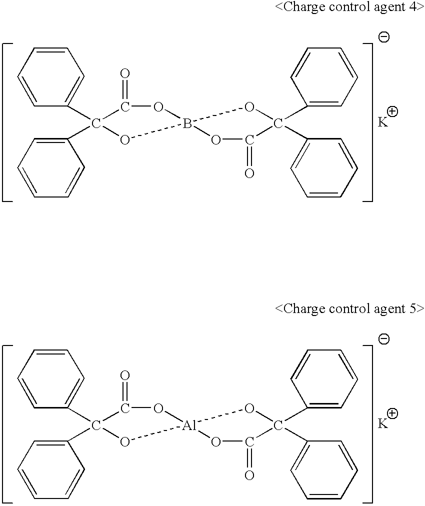

These charge control agents may be used alone or in combination and good charge properties can be obtained by mixing with the binder resin in the amount within a range of 0.3-15 parts by weight, and preferably from 0.5-5 parts by weight.

The dry color toner for electrostatic image development of the present invention is produced by mixing a mixture containing a binder resin having a carboxyl group and an organic pigment of the formula 1 with an aqueous medium in the presence of a base to prepare a colored particle suspension containing the mixture, as color particles, emulsified in the aqueous medium, separating the colored particles from the colored particle suspension, and drying the colored particles. In this case, the toner of the present invention can also be produced by mixing a releasant with the binder resin and the organic pigment of the formula 1, if necessary.

To retain good friction charge properties even when the particle diameter of the toner is reduced, it is effective to prevent the colorant from being exposed on the surface of the toner particles, that is, to attain a toner structure wherein the colorant is contained in the toner particles. The impairment of the charge properties accompanying the reduction in particle diameter of the toner is also caused by the fact that the colorant and other additives (e.g. releasants, etc.) are partially exposed on the surface of the toner particles. Even if the content (% by weight) of the colorant is the same, the surface area of the toner particles is increased by the reduction in particle diameter and the proportion of the colorant, wax or the like to be exposed on the surface of the toner particles is increased. As a result, the composition of the surface of the toner particles drastically changes and the friction charge properties of the toner particles drastically change, thereby making it difficult to obtain proper charge properties.

According to the dry color toner for electrostatic image development produced by the method of the present invention, since the colorant and the releasant, which is optionally added, are included in the binder resin, it is made possible to achieve the object of the present invention, thus obtaining a good printed image.

It can be easily judged, for example, by observing the cross section of the particles employing TEM (transmission electron microscope) to examine that the colorant and wax are not exposed on the surface of the toner particles. More concretely, when the cross section, which was obtained by embedding the toner particles into a resin and cutting the resulting sample by a microtome, is optionally dyed with ruthenium tetraoxide and observed by TEM, it can be confirmed that the pigment and releasant were included in the binder resin and dispersed in particles almost uniformly.

The mixture containing a binder resin having a carboxyl group, a colorant and a releasant, which is optionally added, can be prepared by a conventionally known method. For example, the mixture is prepared by the method of mixing these raw powders and sufficiently kneading employing any of a twin-screw extruder, a kneader and a twin roll. Since the breakage of the high-molecular component of the binder resin occurs sometimes in such a melt-kneading step, it is preferable to select the raw resin after previously confirming a change in molecular weight during the kneading of the binder resin.

As the method of mixing the kneaded mixture thus prepared with the aqueous medium and emulsifying the admixture, for example, a method of emulsifying the kneaded mixture in the aqueous medium by applying high-speed stirring conditions in the presence of a base can be employed. Particularly, when employing this process, it is preferably prepared under the conditions of high temperature and high pressure where the binder resin is softened, thereby making it possible to inhibit the aqueous medium from boiling.

The dry color toner for electrostatic image development of the present invention can also be produced by the method of mixing a binder resin, a colorant and a releasant with an organic solvent, and kneading and dispersing the mixture employing the wet process to obtain the above mixture. In this case, the colorant and releasant as the other additives may be kneaded and dispersed, separately, employing the wet process.

Concretely, it is a method of dissolving the binder resin in the organic solvent, adding the colorant and releasant, dispersing them employing a general mixing/dispersing apparatus such as despa (dispersion stirrer), ball mill, bead mill, sand mill, continuous bead mill or the like, to prepare a resin solution wherein the colorant and releasant are finely dispersed in the organic solvent, mixing the resin solution with an aqueous medium in the presence of a basic neutralizer, thereby emulsifying them, and removing the organic solvent under reduced pressure to prepare the aqueous medium of the colored particles described above. Then, the colored particles are separated from the suspension of the colored particles and dried to obtain a toner. This method is better than the above method wherein high shear is applied to the resin, because the molecular chain of the high-molecular component is not broken, even when the high-molecular component (gel component) exists in the binder resin.

The binder resin employed to produce the dry color toner for electrostatic image development of the present invention is a resin having a carboxyl group. The binder resin having a carboxyl group is converted into a resin with the self-water dispersion by neutralizing the carboxyl group as an acidic group. With respect to the resin with the self-water dispersion, the hydrophilicity increases by converting the acidic group into an anion, whereby the polyester resin is dispersed in the aqueous medium (water or a liquid medium containing water as a principal component).

Examples of the base employed to neutralize the acidic group (carboxyl group) include, but are not limited to, inorganic bases such as sodium hydroxide, potassium hydroxide, and ammonia; and organic bases such as diethylamine, triethylamine, and isopropylamine.

Examples of the organic solvent employed to dissolve or disperse the binder resin, colorant and releasant, which is optionally added, include hydrocarbons such as pentane, hexane, heptane, benzene, toluene, xylene, cyclohexane, and petroleum ether; halogenated hydrocarbons such as methylene chloride, chloroform, dichloroethane, dichloroethylene, trichloroethane, trichloroethylene, and carbon tetrachloride; ketones such as acetone, methyl ethyl ketone, and methyl isobutyl ketone; and esters such as ethyl acetate and butyl acetate. These solvents can be employed alone, or two or more kinds thereof can be employed in combination. The organic solvent dissolves the binder resin and is preferably a solvent having relatively low toxicity and low boiling point, which is easily removed in the subsequent processes. Among these organic solvents, methyl ethyl ketone is most preferable.

A phase inversion agent is preferably added while a mixture containing at least a binder resin made of a polyester resin having a carboxyl group, a colorant, and a releasant is mixed with an aqueous medium in the presence of a base. As used herein, the term “phase inversion agent” refers to those having a phase inversion acceleration function. In the step of adding an aqueous medium (water or a liquid medium containing water as a principal component) in a mixture made of a binder resin, a colorant, and an organic solvent, by gradually adding water to an organic continuous phase of the mixture, a water-in-oil discontinuous phase is formed, which is then converted into an oil-in-water discontinuous phase by further adding water, thus forming a suspension wherein the mixture in the form of particles (droplets) is suspended in the aqueous medium. At this time, those having a phase inversion acceleration function for smoothly accelerating phase inversion of converting into an oil-in-water discontinuous phase from a water-in-oil discontinuous phase refer to a phase inversion agent.

The binder resin employed in the present invention can be dispersed in the aqueous medium without employing the phase inversion agent because the binder resin is provided with the self-water dispersibility by neutralization. However, a powdered toner having a preferable average particle diameter and particle size distribution can be easily produced by employing the phase inversion agent in the binder resin made of the polyester resin which meets the requirements of the toner of the present invention.

The following can be employed as the phase inversion agent in the present invention.

(i) Alcohol Solvent

(ii) Metal Salt Compound

As the alcohol solvent, for example, methanol, ethanol, isopropanol, n-propanol, isobutanol, n-butanol, t-butanol, sec-butanol, ethylene glycol monomethyl ether, propylene glycol monomethyl ether, ethylene glycol monomethyl ether or the like can be employed. As a matter of course, other alcohol solvents can also be employed. Preferred are isopropanol and n-propanol, which dissolve in water and have low boiling point. The amount of the alcohol solvent is within a range of about 10-50 parts by weight based on 100 parts by weight of the solid content of the resin, but is not limited thereto.

As the metal salt compound, conventionally known metal salt compounds can be employed and preferred are salts with metals having two or more valences. Examples thereof include barium chloride, calcium chloride, cuprous chloride, cupric chloride, ferrous chloride, and ferric chloride. The amount of the metal salt compound is within a range of about 0.01-3 parts by weight based on 100 parts by weight of the solid content of the resin, but is not limited thereto.

The method of emulsifying/dispersing the mixture of the binder resin, the colorant, the organic solvent and the phase inversion agent in the aqueous medium is not limited to a special method.

In the method of the present invention, high shear emulsification/dispersion apparatuses and continuous emulsification/dispersion apparatuses can be employed, such as a Homomixer (produced by Tokushu Kika Kogyo Co., Ltd.), a Slasher (produced by Mitsui Mining Co., Ltd.), a Cavitron (produced by Eurotec, Ltd.), a Microfluidizer (produced by Mizuho Kogyo Co., Ltd.), a Munton-Golin Homogenizer (produced by Golin Co.), a Nanomizer (produced by Nanomizer Co., Ltd.), a Static Mixer (produced by Noritake Company) and the like.

However, preferred is a method of adding dropwise water while stirring at low shear employing a stirrer, an anchor blade, a turbine blade, a faudler blade, a full-zone blade, a max blend blade, a semicircular blade or the like at a circumferential speed within a range of 0.2-5 m/second, and preferably within a range of 0.5-4 m/second, as disclosed in Japanese Unexamined Patent Application, First Publication No. Hei 9-114135. By performing emulsification/dispersion at low shear, formation of fine powders can be inhibited and more preferred particle size distribution can be realized.

With respect to the suspension of the spherical or generally spherical colored resin particles obtained by the emulsification, it is preferred that the organic solvent be removed first. Then, solid-liquid separation of the aqueous dispersion is performed by means such as filtration and the particles are dried, thus making it possible to obtain toner particles.

With respect to the suspension of the spherical or generally spherical colored resin particles obtained by the emulsification, it is preferred that the organic solvent be removed and that the hydrophilicity of the particles themselves be lowered by a reverse neutralization treatment wherein acidic and hydrophilic groups neutralized with an acid such as hydrochloric acid, sulfuric acid, phosphoric acid, acetic acid or oxalic acid on the surface of the particles are returned to an original functional group is preferably conducted, followed by removal of water and further filtration and drying.

The drying can be conducted by employing any of conventional known method, and may be conducted at a temperature where the toner particles are not thermally fused or agglomerated under normal pressure or reduced pressure. The freeze-drying method can be employed. There is also a method of simultaneously separating and drying the toner particles from the aqueous medium employing a spray drier. The method of stirring and drying the powder under reduced pressure while heating at the where the toner particles are not thermally fused or agglomerated and the method of employing a flush-jet dryer (produced by Seisin Kigyo Co., Ltd.) capable of drying instantly employing a heat-dry air flow are efficient and preferable.

In the case in which the classification for removing coarse particles and microparticles to adjust the particle size distribution of the formed toner particles is required, it can be conducted by a conventionally known method employing a commercially available general air-flow type classifying machine for toner. In the state where the toner particles are dispersed in the liquid medium, water slurry of the toner particles may be classified by utilizing a difference in sedimentation properties depending on the particle diameter. The removal of the coarse particles can also be conducted by filtering water slurry of the toner particles employing a filter or a wet vibration sieve. With respect to the particle size distribution of the toner, a ratio of 50% particle volume diameter (Dv) to 50% number particle diameter (Dn) as measured by a Coulter Multisizer is preferably 1.35 or less, and preferably 1.25 or less, because good image is easily obtained.

The volume-average particle diameter of the dry color toner for electrostatic image development of the present invention is preferably within a range of 1-15 μm in view of the resulting image quality, and is more preferably within a range of about 3-7 μm. It is particularly preferably within a range of about 3-10 μm. When the volume-average particle diameter is smaller, not only are improved the definition and gradation, but also the thickness of the toner layer for forming the printed image becomes smaller, thereby exerting the effect of reducing the amount of the toner to be consumed per page, which is preferable.

In the present invention, various additives (referred to as external additives) can be employed to improve the surface of the toner base material, such as, for example, to increase the fluidity of the toner, to improve the charge characteristics thereof, or the like. Possible materials employed include, for example, inorganic microparticles such as silicon dioxide, titanium oxide, aluminum oxide, cerium oxide, zinc oxide, tin oxide, zirconium oxide; products resulting when these are subjected to surface treatment employing a hydrophobic treating agent such as silicone oil or silane coupling agent; and fine particles made of resins such as polystyrene, acrylic, styrene-acrylic, polyester, polyolefin, cellulose, polyurethane, benzoguanamine, melamine, nylon, silicone, phenol, and vinylidene fluoride.

Among these, silicon dioxide (silica), the surface of which has been subjected to hydrophobic treatment by means of various polyorganosiloxanes or silane coupling agents, is particularly advantageously employed. Such a product is commercially available under, for example, the following trade names. AEROSIL; R972, R974, R202, R805, R812, RX200, RY200, R809, RX50, RA200HS, RA200H (Nippon Aerosil) WACKER; HDK K2000, H1018, H2050EP, HDK H3050EP, HVK2150 (Wacker Chemicals East Asia) NIPSIL; SS-10, SS-15, SS-20, SS-50, SS-60, SS-100, SS-50B, SS-50F, SS-1OF, SS-40, SS-70, SS-72F (Nippon Silica Industries) CABOSIL; TG820F, TS-530, TS-720 (Cabot Speciality Chemicals Inc.)

The particle diameter of the external additives is preferably one-third or less that of the diameter of the particles, and more preferably one-tenth that diameter or less. Furthermore, these external additives may be simultaneously employed in two types having different average particle diameters.

In the toner for non-magnetic one-component development, by using a toner having a large particle size in combination with a toner having a small particle size, the toner fluidity and development durability are improved, thereby preventing deposition on the blade of the developing machine and fogging and attaining long-term stability of charge during running.

The amount of the external additive is within a range from 0.05-5% by weight, and preferably from 0.1-3% by weight based on 100 parts by weight of the toner as the matrix.

The silica can be externally added to the toner particles, employing a conventional powder mixer such as Henschel mixer and a so-called surface modifying machine such as hybridizer. This external addition treatment may be conducted so that the silica is deposited on the surface of the toner particles or a portion of the silica may be embedded into the toner particles.

The dry color toner for electrostatic image development of the present invention can be employed for development of an electrostatic latent image by means of the electrophotographic method, or employed as a one component developing agent or a two component developing agent mixed with a carrier. The carrier is not specifically limited, and conventionally known carriers can be used such as iron powder, ferrite or magnetite, or carriers prepared by coating them with a resin.

The dry color toner for electrostatic image development of the present invention can be preferably employed in a printer of a so-called toner-jet system employing the method of directly spraying a powdered toner, which is charged frictionally by employing a non-magnetic one component developing apparatus comprising a developing agent bearing roller and a layer control member, over a paper on a back surface electrode through a hole on a flexible printed board with an electrode having a function of controlling the amount of the toner to be passed in the vicinity, thereby forming an image. Since the toner for electrostatic image development of the present invention is superior in fixation properties and color characteristics and has a spherical shape, it becomes easy to control scattering of the toner in a toner-jet system as compared with a toner having a nonuniform shape.

### EXAMPLES

The following Examples and Comparative Examples further illustrate the present invention in detail, but the present invention is not limited thereto. In the following Examples and Comparative Examples, parts are by weight and water means deionized water, unless otherwise specified.

### Synthesis Example of Polyester Resin

Employing terephthalic acid (TPA) and isophthalic acid (IPA) as the dihydric carboxylic acid, polyoxypropylene(2.4)-2,2-bis(4-hydroxyphenyl)propane (BPA-PO) and polyoxyethylene(2.4)-2,2-bis(4-hydroxyphenyl)propane (BPA-EO) as the aromatic diol, and ethylene glycol (EG) as the aliphatic diol in each molar amount shown in Table 1, tetrabutyl titanate as the polymerization catalyst was charged in a separable flask in the amount of 0.3% by weight based on the total amount of monomers. The flask was equipped with a thermometer, a stirrer, a condenser and a nitrogen introducing tube at the upper portion and the mixture was reacted in a electrically heated mantle heater at 220° C. for 15 hours in a nitrogen gas flow under normal pressure and, after gradually evacuating, the reaction was continued under 10 mmHg. The reaction was followed employing the softening point in accordance with the ASTM•E28-517 standard, and the reaction was completed by terminating evacuation when the softening point reached a predetermined temperature to obtain a straight-chain polyester resin R₁.

In the same manner as in R₁, a resin R2 was synthesized. The composition and physical properties (properties) of the synthesized resins are shown in Table 1.

TABLE 1
Composition and properties of resin

| Resin No. | R1 | R2 |
|---|---|---|
| Composition of Resin | | |
| TPA | 36.9 | 46.1 |
| IPA | 9.2 | |
| BPA-PO | 22.5 | |
| BPA-EO | 11.3 | 33.8 |
| EG | 20.1 | 20.1 |
| | 100 mol/% | 100 mol/% |
| Properties of Resin | | |
| T1/2 temperature | 100 | 96 |
| Acid value (KOH mg/g) | 6.7 | 6.5 |
| Tg (° C.) | 54 | 55 |
| Mw (THF-soluble fraction) | 5700 | 5600 |
| Mn (THF-soluble fraction) | 2100 | 2600 |

In Table 1, “T1/2 temperature” is a value as measured by employing a Flow Tester “CFT-500” manufactured by Shimadzu Corporation as a constant load extrusion type capillary rheometer under the conditions of a nozzle diameter of 1.0 mm×1.0 mm, a load of 10 kg (cylinder pressure of 0.98 MPa) per unit area (cm²) and a heating rate of 6° C./min. “Tg” as the glass transition temperature is a value as measured by measuring at a heating rate of 10° C. per minute by the second run method employing a Differential Scanning Calorimeter “DSC-50” manufactured by Shimadzu Corporation.

(Preparation Example of Releasant and Releasant Dispersion)

105 Parts of a releasant, 45 parts of a polyester resin (R1 in Table 1) and 280 parts of methyl ethyl ketone were charged in a ball mill and, after stirring for 18 hours, the mixture was taken out and the solid content was adjusted to 20% by weight to obtain releasant microdispersions (W1-W3). Properties of the resulting releasant dispersions are shown in Table 2.

TABLE 2
Releasant dispersion

| Releasant dispersion | W1 | W2 | W3 |
|---|---|---|---|
| Releasant | Synthetic ester | Carnauba wax | PP |
| Polyester resin | R1 | R1 | R1 |
| Weight ratio of | 70/30 | 70/30 | 70/30 |
| Releasant/resin | | | |
| Solid content (% by | 20 | 20 | 20 |
| weight) | | | |

Releasants shown in Table 2 are as follows. Synthetic ester: tetrabehenate ester of pentaerythritol Carnauba wax: purified carnauba wax No. 1 (manufactured by CERA RICA NODA Limited, acid number: 5) PP: “Viscol 660P” (polypropylene wax produced by Sanyo Chemicals).

(Preparation Example of Colorant Dispersion)

A colorant, a resin and methyl ethyl ketone were charged in a ball mill so that the solid content becomes 35-50% and, after stirring for 18 hours, the mixture was taken out and the solid content was adjusted to 20% by weight to obtain colorant dispersions (P1-P4). Properties of the resulting colorant dispersions are shown in Table 3.

TABLE 3
Colorant dispersion

| Releasant | | | | |
|---|---|---|---|---|
| dispersion | P1 | P2 | P3 | P4 |
| Colorant | Pigment of | C.I. | C.I. | Pigment of |
| | <Formula | PIGMENT | PIGMENT | <Formula |
| | 2> | RED 57:1 | RED 122 | 3> |
| Polyester | R1 | R1 | R1 | R1 |
| resin | | | | |
| Weight ratio | 5/50 | 5/50 | 5/50 | 5/50 |
| of Releasant/ | | | | |
| resin | | | | |
| Solid content | 40 | 40 | 40 | 40 |
| on dispersion | | | | |
| (%) | | | | |
| Dispersion | 18 | 18 | 18 | 18 |
| time (Hour) | | | | |
| Final solid | 20 | 20 | 20 | 20 |
| content (%) | | | | |

Colorants shown in Table 3 are as follows. C.I.PIGMENT RED 57:1; Symuler Brilliant Carmin 6B 285 (manufactured by Dainippon Ink and Chemicals, Inc.) C.I.PIGMENT RED 122; Fastogen Super Magenta R (manufactured by Dainippon Ink and Chemicals, Inc.)

(Preparation of Wet Kneaded Mill Base)

The above colorant dispersion, a resin and methyl ethyl ketone were mixed employing a despa and the solid content was adjusted to 50% by weight to obtain mill bases (MB1-MB6). Each formulation of the mill bases thus prepared is shown in Table 4.

TABLE 4
Formulation of mill base

| | Colorant | Polyester | | |
|---|---|---|---|---|
| Mill base | dispersion | resin | MEK | Solid content |
| MB1 | P1 = 100 parts | R1 = 80 parts | 20 parts | 50% |
| MB2 | P1 = 200 parts | R1 = 60 parts | — | 38% |
| MB3 | P1 = 100 parts | R2 = 80 parts | 20 parts | 50% |
| MB4 | P2 = 100 parts | R1 = 80 parts | 20 parts | 50% |
| MB5 | P3 = 100 parts | R1 = 80 parts | 20 parts | 50% |
| MB6 | P4 = 100 parts | R1 = 80 parts | 20 parts | 50% |

### Example 1

600 parts of MB1 shown in Table 4, 100 parts of W1 shown in Table 2, 57.5 parts of methyl ethyl ketone, 29.0 parts of isopropyl alcohol as the phase inversion accelerator and 25.8 parts of an aqueous 1 N ammonia solution were charged in a cylindrical vessel, followed by sufficient stirring. Subsequently, 230 parts of water was added and the liquid temperature was raised to 30° C. Then, 44 parts of water was added dropwise while stirring, thereby performing phase inversion emulsification. The circumferential speed was 1.05 m/second. After the stirring was continued for 30 minutes, the rotation was terminated and 400 parts of water was added.

Water slurry of particles was observed by an optical microscope. As a result, agglomerates of the releasant were not observed and a flowing releasant was not observed. The particle size distribution was measured by a Coulter Counter. As a result, 50% particle volume diameter/50% number particle diameter (Dv/Dn) was 1.31 and the occurrence of coarse particles was not observed.

The solvent was removed by vacuum distillation, followed by filtration and washing with water. The resulting wet cake was dispersed again in water and, after controlling the pH to 4 by adding an aqueous 1 N hydrochloric acid solution, filtration and washing with water were repeated. The wet cake thus obtained was freeze-dried and then classified by an air-flow type classifying machine to obtain toner particles having the volume-average particle diameter of 6.5 μm and the average roundness of 0.981.

The resulting toner particles were embedded into a resin and the resulting sample was cut by a microtome, and then the cross section dyed with ruthenium tetraoxide was observed by TEM (transmission electron microscope) . As a result, the pigment and wax were included in the binder resin and dispersed in particles nearly uniformly. Employing a Henschel mixer, 2 parts of a hydrophobic silica (SILICA RY200, manufactured by (Nippon Aerosil) was externally added to 100 parts of the resulting toner particles to obtain a powdered toner (toner for electrostatic image development).

### Example 2

790 Parts of MB2 shown in Table 4, 100 parts of W2 shown in Table 2, 28.0 parts of isopropyl alcohol as the phase inversion accelerator and 26.5 parts of an aqueous 1 N ammonia solution were charged in a cylindrical vessel, followed by sufficient stirring. Subsequently, 230 parts of water was added and the liquid temperature was raised to 30° C. Then, 44 parts of water was added dropwise while stirring, thereby performing phase inversion emulsification. The circumferential speed was 1.05 m/second. After the stirring was continued for 30 minutes, the rotation was terminated and 400 parts of water was added.

Water slurry of particles was observed by an optical microscope. As a result, agglomerates of the releasant were not observed and a flowing releasant was not observed. The particle size distribution was measured by a Coulter Counter. As a result, Dv/Dn was 1.34 and the occurrence of coarse particles was not observed.

The solvent was removed by vacuum distillation, followed by filtration and washing with water. The resulting wet cake was dispersed again in water and, after controlling the pH to 4 by adding an aqueous 1 N hydrochloric acid solution, filtration and washing with water were repeated. The wet cake thus obtained was freeze-dried and then classified by an air-flow type classifying machine to obtain toner particles having the volume-average particle diameter of 5.1 μm and the average roundness of 0.982.

The resulting toner particles were embedded into a resin and the resulting sample was cut by a microtome, and then the cross section dyed with ruthenium tetraoxide was observed by TEM (transmission electron microscope) . As a result, the pigment and wax were included in the binder resin and dispersed in particles nearly uniformly. Employing a Henschel mixer, 2 parts of a hydrophobic silica (SILICA RY200, manufactured by (Nippon Aerosil) was externally added to 100 parts of the resulting toner particles to obtain a powdered toner (toner for electrostatic image development).

### Comparative Example 1

85 Parts of the resin R1shown in Table 1, 5 parts of a tetrabehenate ester of pentarythritol as the releasant and 10 parts of a pigment of <formula 2> as the colorant were kneaded in a twin-screw extruder and the kneaded mixture was pulverized and then classified to obtain a powdered toner (Comparative Example 1-1) having the volume-average particle diameter of 5.4 μm and a powdered toner (Comparative Example 1-2) having the volume-average particle diameter of 7.6 μm, respectively. The resulting powdered toners were observed by TEM (transmission electron microscope) in the same manner as in the case of those of Examples 1 and 2. As a result, the pigment and wax was partially exposed on the surface of any of the toner particles.

### Other Examples and Comparative Examples

The powdered toners of the other Examples and Comparative Examples were produced in the same manner as in Example 1. The powdered toner of Example 5 was produced in the same manner as in Example 2. The amount of MB (mill base) and the releasant dispersion, the amount of pigment/releasant/resin reduced based on the solid content, and measured value of average roundness of the powdered toners of the respective Examples and Comparative Examples are shown in Table 5.

TABLE 5

| | | Releasant | Pigment/Releasant/Resin | Dv | Average | Particle size |
|---|---|---|---|---|---|---|
| | Mill base | dispersion | (amount based on solid content) | (μm) | roundness | distribution |
| Example 1 | MB1 | W1 | 30 parts/14 parts/276 parts | 6.5 | 0.981 | 1.31 |
| | 600 parts | 100 parts | | | | |
| Example 2 | MB2 | W2 | 60 parts/14 parts/246 parts | 5.1 | 0.982 | 1.34 |
| | 790 parts | 100 parts | | | | |
| Comp. | | Synthetic | 10 parts/5 parts/85 parts | 5.4 | 0.920 | |
| Example 1-1 | | ester | | | | |
| Comp. | | Synthetic | 10 parts/5 parts/85 parts | 7.6 | 0.898 | |
| Example 1-2 | | ester | | | | |
| Example 3 | MB3 | W1 | 30 parts/14 parts/276 parts | 7.2 | 0.976 | 1.37 |
| | 600 parts | 100 parts | | | | |
| Example 4 | MB1 | W3 | 30 parts/14 parts/276 parts | 5.4 | 0.978 | 1.43 |
| | 600 parts | 100 parts | | | | |
| Example 5 | MB2 | W1 | 60 parts/14 parts/246 parts | 6.9 | 0.980 | 1.43 |
| | 790 parts | 100 parts | | | | |
| Example 6 | MB6 | W1 | 30 parts/14 parts/276 parts | 6.3 | 0.982 | 1.32 |
| | 600 parts | 100 parts | | | | |
| Comp. | MB4 | W1 | 30 parts/14 parts/276 parts | 5.6 | 0.976 | 1.31 |
| Example 2 | 600 parts | 100 parts | | | | |
| Comp. | MB5 | W1 | 30 parts/14 parts/276 parts | 5.7 | 0.976 | 1.33 |
| Example 3 | 600 parts | 100 parts | | | | |

Notation in Table 5
Synthetic ester: tetrabehenate ester of pentarythritol

(Fixation Properties Test)

With respect to the fixation temperature range, the fixation temperature was determined by the following fixation properties test and the range between the upper limit and the lower limit was taken as the fixation temperature range. Employing each of the powdered toners of the Examples and Comparative Examples, the respective test samples were made by forming an unfixed image on a paper by a transformed printer that employs a commercially available organic semiconductor as a photosensitive material, and then fixed by passing through a heat roller (oilless type) Richo Imadio DA-250 at a speed of 90 mm/second, and then a Cellophane tape was applied on the image after fixation. The surface temperature range of the heat roller when ID (image density) after peeling is 90% or more of the original ID and offset does not occur was defined as a “fixation temperature”. The results are shown in Table 6.

(Printing Test)

Employing a commercially available negatively charging type non-magnetic single-component development system printer, the fogging, definition, gradation, OHP permeability, transfer efficiency and image density of the powdered toners of the respective Examples and Comparative Examples were evaluated. The evaluation results are shown in Table 6. With respect to the fogging, definition and gradation, the images were visually observed employing a test pattern. The results were evaluated by the following criteria.

∘: better than standard

⊚: even better

The transfer efficiency was shown by the values determined by the following method of measuring the transfer efficiency. The image density was measured employing a Macbeth densitometer RD-918.

(Method of Measuring the Transfer Efficiency)

Employing a commercially available negatively charging type non-magnetic one-component development system printer, a solid image (100 m long and 20 mm broad) was developed and the printer was stopped when the solid image on the photosensitive material passed through the transferring portion by 50%. Then, the image on the photosensitive material after transferring the non-transferred image (solid) was completely peeled off by a tape (30 mm×20 mm) and the amount of the toner of the non-transferred image and the amount of the toner after transferring were measured. The transfer efficiency (%) is calculated by the following equation.

$$Transfer efficiency = 100 - \frac{amount of toner after transferring}{amount of toner of non \text{-} transferred image} \times 100$$

Furthermore, the OHP transparency was evaluated by the following method of evaluating the OHP sharpness.

(Method of Evaluating OHP Sharpness)

A non-fixed image due to a color toner was formed on an OHP sheet and the non-fixed image was fixed by a separately prepared fixing tester. The OHP sheet was fixed by passing through a heat roller (oilless type) Richo Imadio DA-250 at a heat roller temperature of 160° C. at a speed of 90 mm/second. A black-printed OHP sheet was placed on the OHP sheet made in the above procedure and was projected on a screen by an overhead projector, and then the sharpness of letters was visually observed. The results were evaluated by the following criteria.

◯: sharp letters

×: blurred letters

TABLE 6

| | | | | | | Transfer | Fixation |
|---|---|---|---|---|---|---|---|
| | | | | OHP | Image | efficiency | temperature |
| | Fogging | Definition | Gradation | permeability | density | (%) | range (° C.) |
| Example 1 | ◯ | ◯ | ◯ | ◯ | 1.48 | 97 | 115-150 |
| Example 2 | ⊚ | ⊚ | ⊚ | ⊚ | 1.55 | 98 | 115-150 |
| Comp. | X | X | X | standard | 1.40 | 84 | 120-150 |
| Example 1-1 | | | | | | | |
| Comp. | standard | standard | standard | standard | 1.42 | 85 | 120-150 |
| Example1-2 | | | | | | | |
| Example 3 | ⊚ | ◯ | ◯ | ◯ | 1.45 | 97 | 115-150 |
| Example 4 | ◯ | ⊚ | ◯ | standard | 1.42 | 98 | 125-155 |
| Example 5 | ⊚ | ⊚ | ◯ | ⊚ | 1.54 | 98 | 115-150 |
| Example 6 | ⊚ | ◯ | ◯ | ⊚ | 1.48 | 98 | 115-150 |
| Comp. | standard | ◯ | standard | standard | 1.35 | 92 | 115-150 |
| Example 2 | | | | | | | |
| Comp. | standard | ◯ | standard | standard | 1.20 | 91 | 120-150 |
| Example 3 | | | | | | | |

It was confirmed from the results shown in Table 6 that the toners of the Examples of the present invention are superior in fogging, definition, gradation, transfer efficiency and image density. OHP permeability was also evaluated. It was confirmed that clear projected images having an excellent transparency can be obtained in all Examples. Using the toners of the respective Examples, a coated paper having a matte surface was printed. As a result, printed images having a sufficient density were obtained in a small coating weight. Moreover, the resulting prints had a subdued tone without unnecessary gloss at the solid portion and without deteriorating a matte surface condition of a paper.

What is claimed is:

1. A spherical dry color toner for electrostatic image development, comprising a binder resin and an organic pigment dispersed finely in the binder resin, wherein the organic pigment is an organic pigment represented by the formula 1: 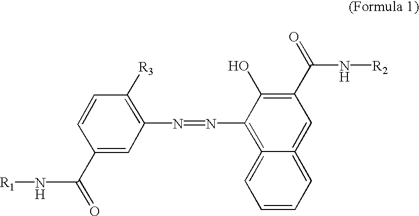
wherein R₁ represents a non-substituted phenyl group or a phenyl group having a substituent, R₂ represents hydrogen, a non-substituted phenyl group or a phenyl group having a substituent, and R₃ represents an alkoxy group or an ester group.

2. A spherical dry color toner for electrostatic image development according to claim 1, wherein an average roundness of the color toner is 0.93 or more.

3. A spherical dry color toner for electrostatic image development according to claim 1, wherein an average roundness of the color toner is 0.97 or more.

4. A spherical dry color toner for electrostatic image development according to claim 1, wherein an average roundness of the color toner is 0.98 or more.

5. A spherical dry color toner for electrostatic image development according to claim 1, wherein the organic pigment is an organic pigment represented by the formula 2:

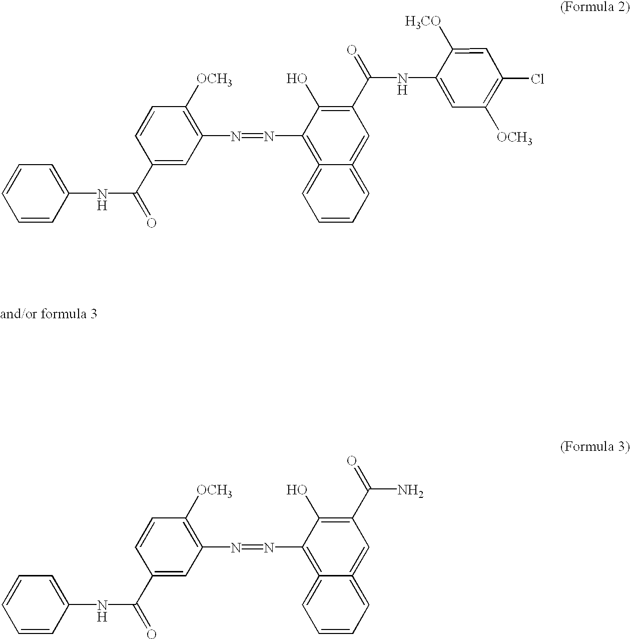

6. A spherical dry color toner for electrostatic image development according to claim 1, wherein the binder resin is a polyester resin and/or a vinyl copolymer resin.

7. A spherical dry color toner for electrostatic image development according to claim 1, wherein the binder resin has a carboxyl group and the acid value is within a range from 1-30.

8. A method of producing the spherical dry color toner for electrostatic image development of claim 1, which comprises mixing a mixture containing a binder resin having a carboxyl group and an organic pigment represented by the formula 1 with an aqueous medium in the presence of a base to prepare a colored particle suspension containing the mixture, as color particles, emulsified in the aqueous medium, separating the colored particles from the colored particle suspension, and drying the colored particles.

9. A method of producing the spherical dry color toner for electrostatic image development according to claim 8, wherein the mixture is prepared by previously dissolving or dispersing a binder resin and a colorant in an organic solvent and then the resulting solution or dispersion is mixed with an aqueous medium.

10. A method of producing the spherical dry color toner for electrostatic image development of claim 9, wherein the mixture is mixed with an aqueous medium in the presence of a phase inversion accelerator.

11. A method of producing the spherical dry color toner for electrostatic image development according to claim 10, wherein the phase inversion accelerator is an alcohol solvent.
